(19) United States
(12) Patent Application Publication
(10) Pub. No.: US 2020/0334315 A1
(43) Pub. Date: Oct. 22, 2020

(54) ENHANCED DOCUMENT SEARCHING SYSTEM AND METHOD

(71) Applicant: Yijun Du, Scarborough (CA)

(72) Inventor: Yijun Du, Scarborough (CA)

(21) Appl. No.: 16/754,144

(22) PCT Filed: Nov. 10, 2017
(86) PCT No.: PCT/CA2017/051342

§ 371 Date: Apr. 7, 2020

(51) Int. Cl. G06F 16/9538; G06F 16/955

(52) U.S. Cl. CPC G06F 16/9538; G06F 16/9558

(57) ABSTRACT

Methods of generating and presenting search results to a user of a search engine who has executed a search query using one or more keywords are described. A method includes receiving a set of search results in response to the search query made by the user, generating, for each document hyperlinked to a search result, a preview document image that identifies the keywords from the search query found in the hyperlinked document using a color-based scheme or a symbol-based scheme or combination of both, and presenting the set of search results in a document with a user interface element for each document hyperlinked to a search result which when activated causes the associated preview document image to be displayed to the user.

### FIELD OF THE INVENTION

The present specification relates generally to search systems and methods and more specifically relates to document searching on computers, particularly those which are network-connected to the World Wide Web via the Internet.

### BACKGROUND OF THE INVENTION

Search engines are used to generate a set of documents (results) from a collection of data in response to a user's search query. The search query is typically a list of terms or keywords relating to the search objective, and may include Boolean logic operators to limit or refine the results.

When the size of the collection is very large, such as is the case with the World Wide Web, the number of matching documents for a given query will likely be very large, and well beyond the capacity of the user to thoroughly examine. Thus, most search engines, particularly those which index the World Wide Web, include some form of relevance ranking to the search results. However, most ranking systems are confidential and proprietary, making it unclear to the user how best to structure their search query to produce their desired results. Furthermore, ranking systems may be subject to manipulation (e.g. paid results, incorrect metadata, URL redirection) that may produce misleading or irrelevant results to the user.

Accordingly, there remains a need for improvements in the art.

### SUMMARY OF THE INVENTION

In accordance with an aspect of the invention, there is provided a method of generating and presenting enhanced search results to a user of a search engine who has executed a search query using one or more keywords, comprising: receiving a set of search results in response to the search query made by the user; generating, for each document hyperlinked to a search result, a preview document image that identifies the keywords from the search query found in the hyperlinked document using a color-based scheme or a symbol-based scheme or combination of both; and presenting the set of search results in a document with a user interface element for each document hyperlinked to a search result which when activated causes the associated preview document image to be displayed to the user.

In accordance with a further aspect of the invention, the color-based scheme or symbol-based scheme may further identify images, videos and hyperlinks from the document, or scripted elements within the document, or both. Non-visible elements associated with the document, such as document length, document format, and date of publication may also be displayed via the preview document image or its associated anchor icon or image.

In accordance with a still further aspect of the invention, there is provided a non-transient, computer-readable medium containing computer-readable instructions, which when executed by a processor cause the computer to: receive a set of search results in response to the search query made by the user; generate, for each document hyperlinked to a search result, a preview document image that identifies the keywords from the search query found in the hyperlinked document using a color-based scheme or a symbol-based scheme or combination of both; and present the set of search results in a document with a user interface element for each document hyperlinked to a search result which when activated causes the associated preview document image to be displayed to the user.

In accordance with a further aspect of the invention, there is provided a method of presenting a user with non-term search options and refining a set of hyperlinked search results of a search session, comprising: receiving the set of hyperlinked search results in response to a search query made by the user; generating, for each hyperlinked search result, an interactive button permitting the user to set an at least one non-term search condition to be applied to the set of hyperlinked search results; applying the at least one non-term search condition to the set of hyperlinked search results to obtain a refined set of hyperlinked search results; and presenting the refined set of hyperlinked search results to the user.

In accordance with a further aspect of the invention, there is provided a method of presenting a search session to a user, receiving a search query from the user, the search query containing one or more terms or non-term conditions; presenting the user's search query to the user as a search tree, the search tree containing a first parent node representing the search query; presenting the user with a first query-focusing term or non-term condition, the first query-focusing term or non-term condition available to modify the search tree to add a first tier first child node connected to the first parent node, the first tier first child node representing the first query-focusing term or non-term condition; presenting the user with a first query-broadening term or non-term condition, the first query-broadening term or non-term condition available to modify the search session presentation to add a supplemental search tree containing a second parent node, the second parent node representing the first search query as modified by the first query-broadening term or non-term condition; receiving a first search query modification request from the user, the first search query modification request modifying the search query to add or remove a first term or non-term condition; modifying the search tree to add a first tier first child node, the first tier first child node connected to the first parent node and representing the first search query modification; and modifying the search tree to add an at least one first tier unsorted child node, the at least one first tier unsorted child node connected to the first child node and representing the search query less the first search query modification.

Other aspects and features according to the present application will become apparent to those ordinarily skilled in the art upon review of the following description of embodiments of the invention in conjunction with the accompanying figures.

### BRIEF DESCRIPTION OF THE DRAWINGS

Reference will now be made to the accompanying drawings which show, by way of example only, embodiments of the invention, and how they may be carried into effect, and in which:

FIG. 1 is a screenshot of a preview document image according to an embodiment;

FIG. 2 is a screenshot of a preview document image with mouseover text, according to an embodiment;

FIGS. 3A-D are screenshots of preview document images according to an embodiment.

FIG. 4A is a depiction of a view port of an entire emphasis preview document image, according to an embodiment;

FIG. 4B is a depiction of an entire true preview document image corresponding to the emphasis preview document image of FIG. 4A.

FIG. 5 is a screenshot of a show/hide menu button according to an embodiment;

FIG. 6 is a screenshot of a show/hide meu according to an embodiment; and

FIG. 7 is a screenshot of a search session tracker according to an embodiment.

Like reference numerals indicated like or corresponding elements in the drawings.

### DETAILED DESCRIPTION OF THE EMBODIMENTS

The present invention and its embodiments relate to search engines, user search queries, presentation of search results, and improvements thereto.

In the following description the terms ‘document’ and ‘search results’ are both to be understood as applying to such search returns as webpages and personal files.

Relevance and Ranking Scores

Relevance is defined in terms of a user's information needs. A document may be considered relevant to a user query based on both variables concerning the document itself (scope, type, context) as well as variables concerning the user (motivation, previous knowledge). With that in mind, relevance may not be a static concept, but state-based according to the individual user at the time of their search.

Currently in the art, as part of efforts to automate and simplify search engines to accommodate as many users as possible, most search engines operate using static ranking algorithms based on the apparent most common needs of all users. The various, and generally undisclosed, factors included in the algorithms attempt to simulate these needs and a ranking score is produced based on combining all these factors for each document in the search results.

Consequently, many ranking scores lack any practical relevance to the user. The combined single score often cannot be broken into components by the user and, even if it were possible, the components would likely not have any meaning to the user.

Additionally, the combined score may result in documents with different content types and documents with different dominant factors being merged into the overall result set. Thus, the only certain commonality between documents is in the combined score, and passes further refining efforts and labor on to the user. While the combined score may result in some relevant pages making the top of the result list for certain needs, the user is still responsible for reviewing the search results and choosing or rejecting the individual documents based on their personal needs.

For Internet search engines, the results are typically presented as the document (webpage) title, web address (URL) and a brief content snippet from the document, in order to minimize the list size and keep the results as compact as possible. However, as a consequence, it is difficult for users to recognize relevant material and reject irrelevant or useless results. For example, the context of the content snippet is absent, and where keywords are present in multiple locations in the document it is not shown and there is no guarantee that the “right” snippet is presented to the user. Thus, even when present, relevant pages may be unrecognizable and skipped by the user, or irrelevant results mislead the user into accessing them.

Users may be familiar with the limitations of the existing search engines, and address the limitations by checking through the original documents in the search set. However, this increases the user effort required, as each page must be downloaded and rendered, and then reviewed to identify the location and context of the snippet presented in the search to determine the relevance of the document.

In a search, missing a relevant document may be more harmful than reviewing an irrelevant one, yet the effort involved in validating the relevance of results continually presents the user with a dilemma: either to skip a result, or to spend the effort to examine the document, without necessarily having sufficient information to make the decision.

The effort required may further lead the user to abandon the search prematurely before finding relevant results, and may leave doubts about the final outcome even where some relevant results were found, which in either case generally defeats the objective of the original search.

Words and Limitations

The most common form of search request is based on the use of one or more keywords which express the user's search need and act as the primary control for inclusion of documents in the results. The content of the results may be changed through adding, deleting or changing the keywords from the original search query.

However, keywords alone may often be insufficient to fully express the user's search needs. For example, document parameters such as date of publication, or file format, may be important to the user's search needs. Another factor which may be important to determining relevance is the position of the keyword in the document e.g. in the title, or in the main body of text, or as a caption to an image. These types of non-term conditions may be used to generate search results that are relevant to the user's needs.

Additionally, the keywords themselves may need to function differently within the query. In natural language, documents may share a keyword yet the word itself has a different meaning based on the document context. In order to differentiate results, more keywords may be needed, but may also be difficult to identify. And, in some cases, it may be easier to differentiate the undesired results than the desired one. For example, a search for “jaguar” may be for a type of animal, or a type of luxury car. If the user is searching for the animal, adding “habitat” may or may not produce more relevant results, at different degrees of possibility, depending on the user's need, but, on the other hand, excluding a term, such as “x-type”, may remove significantly more irrelevant (to the user) results. Thus, in some cases, it may be more efficient to exclude results for irrelevant topics first, particularly where they would otherwise occupy higher positions in the results set.

The ability to provide such additional operations may be provided through separate so-called “advanced search” functions available to the user. However, in practice, searchers rarely engage these functions, or fail to do so in an efficient manner. Some of it may be psychological, as user's see “advanced” and interpret the functions as optional or difficult, when the functions should instead be considered as valuable and important in producing relevant results with efficient, rather than wasted, effort.

Another issue is in presenting these options, as they are often located on a separate page, and the number of options and terminology varies from one search engine to another. Thus, users are forced to abandon existing search queries when moving to an advanced search page, as often the need for additional functions only becomes apparent after initiating a search, and the lack of consistency makes it more difficult to determine which functions should be applied, and how to apply them.

Advanced search functions are also often presented in a linear layout, requiring a user to go through a list to find appropriate options. It is often difficult to maintain an order and layout of options that is familiar to a user during the updating of a linear layout. It is also often difficult to maintain convenient list length when using a linear layout. Additionally, while many search engines recommend search terms, many advanced search tools also do not offer recommended terms or non-term options.

It is also often difficult to provide a meaningful depiction or description of a non-term condition or option to a user in a linear list provided in an advanced search page.

Users' search needs and the evolution and volume of documents available suggest obtaining greater relevancy of results, and greater tools for generating relevant results, is desirable, yet the majority of Internet-based searches are still keyword searches.

Relevance

The use of keywords and other conditions in existing search requests is driven by the necessity to extract relevant documents into the search results or answer set and separate out the irrelevant ones (i.e. blocking them) so that the size of the answer set may be reduced and the density of relevant materials in the answer set increased.

With that in mind, the user should be provided with available options to describe their need within the search query and retrieve more relevant documents. Ideally, when a search query is specific enough, effectively all the irrelevant results may be suppressed and only relevant documents presented.

However, the current state of the art is dominated by short queries, and adding additional terms immediately modifies the static ranking systems, but in a negative manner. For example, even with just two keywords, the ranking algorithm is forced to decide how to rank two pages, where one has the first keyword in the title, and the other has the second keyword in the title. There is no “correct” answer that applies to all users. Thus, even adding keywords may negatively impact the results and create unpredictability in the result set.

Other attempts to address this issue have other problems. Another technique is to rank on importance or popularity. However, it is unclear as to how strongly this methodology may differentiate pages and furthermore, may introduce a bias towards older documents over newer documents, leading to a long-term degradation in the search process and results.

As a consequence, users have begun to avoid adding new terms due to the degradation of results, except in those cases where the user has used the “right” terms, relative to the search engine and algorithm, rather than the user's needs.

Additional challenges are introduced by synonymy (users may use different words to search for the same object) and polysemy (words have more than one specific meaning). Similar challenges may arise with the use of non-term selection and separation conditions.

Again, user attempts to overcome these challenges are often to either use more keywords and conditions, which raises the problem above, while still leaving the issue of excluding documents that lack the exact terms; or to restrain the number of terms and conditions to get better coverage of relevant documents, but while also introducing larger numbers of irrelevant documents in the results.

Furthermore, users are provided little guidance in techniques to determine the right keywords and conditions for their search needs. Suggestions tend to be limited to additional common related terms, which the user is most likely aware of. There are no suggestions to overcome synonymy, and no capability to provide suggestions for non-term options.

Absent suggestions, users may resort to reviewing the set of results and extrapolating from those themselves. This process often results in a multi-stage search where the user iterates through reviewing results and adjusting queries until a satisfactory, if not necessarily complete, result is achieved. The user is also required to exert themselves through a process that may be more readily achieved by the search engine, if properly constructed.

Boolean searches are commonly recommended to address both precision and coverage in the set of results. A detailed Boolean query may read:
(term 1a OR term 2a OR term 3a) AND (term 1b OR term 2b) AND (NOT (term 1c OR term 2c)

However, this example expression demonstrates some of the issues with Boolean queries. They may be difficult to form, having to account for the Boolean terms, connectors and nesting, and consequently also hard to interpret. Additionally, they may be difficult to maintain and update. Finally, and significantly, they may be hard to use, as the interaction of the Boolean operators with the search ranking algorithm may be unclear or even dysfunctional, producing results that lack not only relevance, but any apparent rationale for the lack of relevance.

Additionally, due to the linear nature of browser based search inquiries, it becomes very difficult to enter and track multiple combinations or keywords and Boolean operators. It becomes incumbent upon the user to track their results and past queries without support from the search engine. And prioritizing the “right” combinations becomes unduly critical for achieving results in a satisfactory time and manner.

Interface issues may also arise, as the keyboard/mouse combination required to change keywords and terms, and switching between pages of results may become laborious over time, particularly if multiple queries are being executed. Further, keeping track of past queries for future use, either in the current search or a future one, is difficult and the context is not maintained.

It is also inefficient to proceed through combination by trial and error. The single-threading of the results leads to broken chains of searching, as well as overlapping and repeating results, making it unclear which sets of results are most relevant. Users get little help in viewing the entire space and pattern of their results, or with suggestions to improve and advance the process with their next query. Thus, users often abandoned further attempts without seeing any benefit from their efforts to improve their search queries.

Collection statistics may assist in providing all the options at once, however, they are generally not currently visible to the user, or not in a contextual fashion in relation to the search query. Even with that, without the intermediate results connecting the original search query and the user's needs, the information presented may be as likely to produce worse results as it is to improve them.

Preview Search Result Image

According to an embodiment of the present invention, search results are retrieved, such as search results retrieved from an existing internet search engine, and are processed according to the methods described herein. However, alternative methods are possible, such as managing the results entirely at the search engine, or executing the process entirely on the user's computing device, such as, for example, conducting a document or file search on a private comping device or network. The software may operate as stand-alone, or as an expansion or plug-in to an existing software program, such as a web browser.

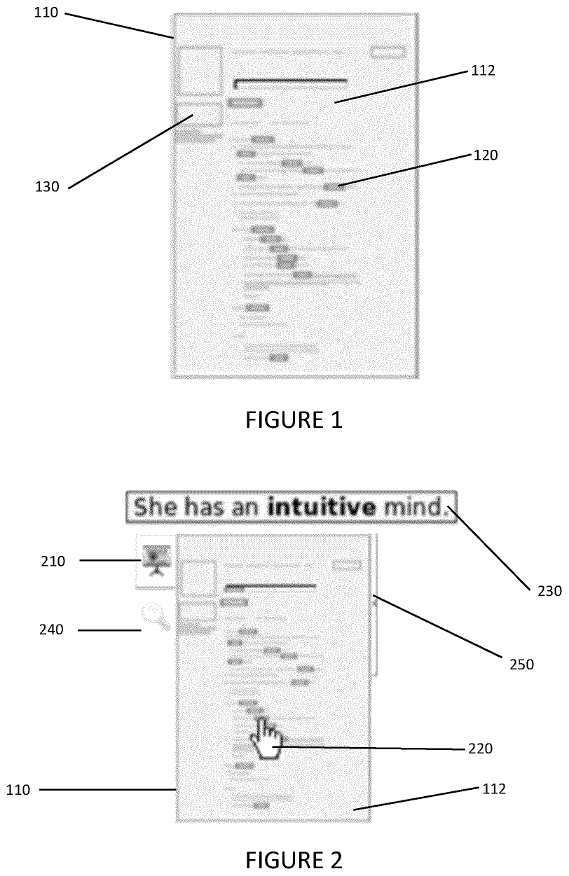

According to an embodiment of the present invention, search results returned by a search, such as a search using an internet search engine, are provided with a preview document image or preview search result image or snapshot 110 for each search result, as shown in FIGS. 1 to 4B. Snapshot 110 provides the user with a look at the search result, without requiring the user to leave the search results listing to access the document itself. This may enable the user to determine the relevance of a document without the need to click through and examine the document itself.

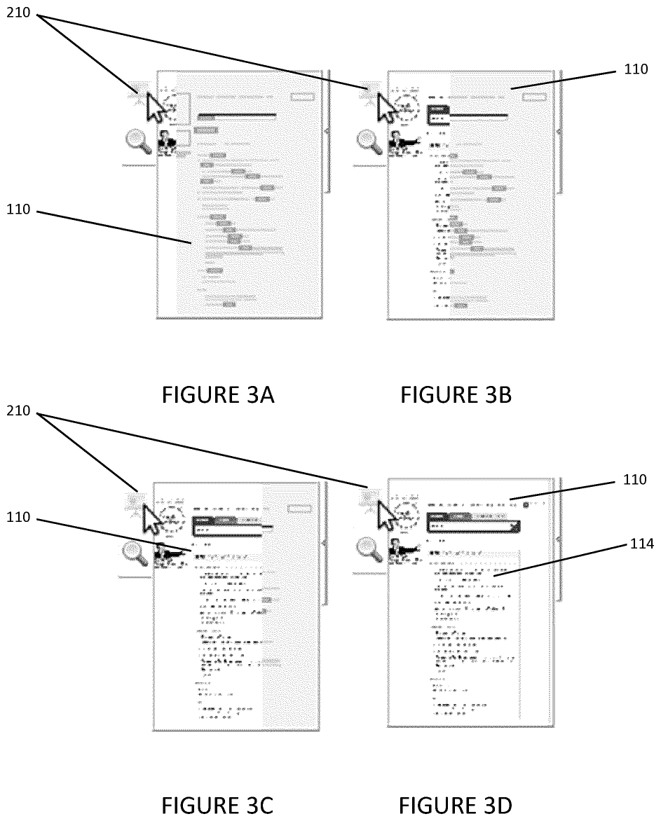

The preview document image, such as snapshot 110, provides a depiction of the search result. Snapshot 110 may include one or both of an emphasis depiction snapshot 112 and a true depiction snapshot 114. In some embodiments, the snapshot 110 is provided to a user as an emphasis depiction snapshot 112, which may be an emphasis depiction of at least a portion of a search result or may be a true depiction of at least a portion of a search result having a superimposed emphasis depiction. For example, the snapshot in FIG. 1 is an emphasis depiction snapshot 112 of a webpage, the snapshot being provided in response to a triggering event such as a mouseover event on a snapshot icon associated with a search result in a search result listing. In other embodiments, the snapshot 110 is provided to the user as a true depiction snapshot 114 of at least a portion of a search result. For example, the snapshot in FIG. 3D is a true depiction snapshot 114 of a webpage.

In other embodiments, snapshot 110 may be toggled between an emphasis depiction snapshot 112 and a true depiction snapshot 114. For example, activating toggle switch or button or interface 210 may permit a user to transition from an emphasis depiction snapshot 112 to a true depiction snapshot 114. In some embodiments, toggle 210 may be triggered by a hovering mouseover event, resulting in a sliding transition between the emphasis depiction and the true depiction. For example, as depicted in stages in FIGS. 1 and 3A-3D from FIG. 1 to FIG. 3D, a hovering mouseover event may result in sliding removal of emphasis depiction, which may be either the removal of an emphasis depiction snapshot 112 overlay of the true depiction snapshot 114 or may be a replacement of an emphasis depiction snapshot 112 by a true depiction snapshot 114.

The emphasis depiction snapshot 112 may be generated as a symbolized and color-coded representation of a hyperlinked search result in the search results listing through the use of a color-based scheme, a symbol-based scheme, or a combination of both a color-based scheme and a symbol-based scheme.

In some embodiments, the emphasis depiction snapshot 112 does not include irrelevant or less relevant information. For example, the emphasis depiction snapshot 112 may replace advertisements or irrelevant images with blank boxes or boxes containing or associated with an indication of what was replaced. The emphasis depiction snapshot 112 may also remove irrelevant lines or other search result content. Removing irrelevant content enables some users to more easily review relevant information.

In some embodiments, one or more of the emphasis depiction snapshot 112 and the true depiction snapshot 114 may have a different layout than the corresponding search result, and may display only relevant portions of the search result. For example, one or more of the emphasis depiction and the true depiction may display a combination of lines or other elements corresponding to keywords or non-term conditions rather than showing the search result as it is. In such embodiments, the true depiction snapshot 114 is not true in the sense of showing the search result exactly as it is, but only in not applying the color or symbol based modification scheme applied to the emphasis depiction snapshot 112. In some embodiments, where the emphasis depiction snapshot 112 displays a different layout than the underlying search result, the true depiction snapshot 114 displays a layout corresponding to the emphasis depiction snapshot 112.

In some embodiments, displaying a different layout than the corresponding search result enables the emphasis depiction snapshot 112 and the true depiction snapshot 114 to condense the relevant portions into a more manageable snapshot, and may enable the snapshot 110 to also emphasize a summary or abstract provided by an author of the search result, even where the summary or abstract does not correspond to any particular search term or non-term condition; thus enabling the user to get a more coherent summary of the search result. However, having emphasis and true depictions which do not have layouts corresponding directly to the underlying search result risks confusing a user who then accesses the search result or distorting the relevance information. Therefore, in some embodiments the layouts of the emphasis snapshot 112 and true snapshot 114 directly correspond to the layout of the underlying search result; and true depiction snapshot 114 is an unaltered depiction of the corresponding search result.

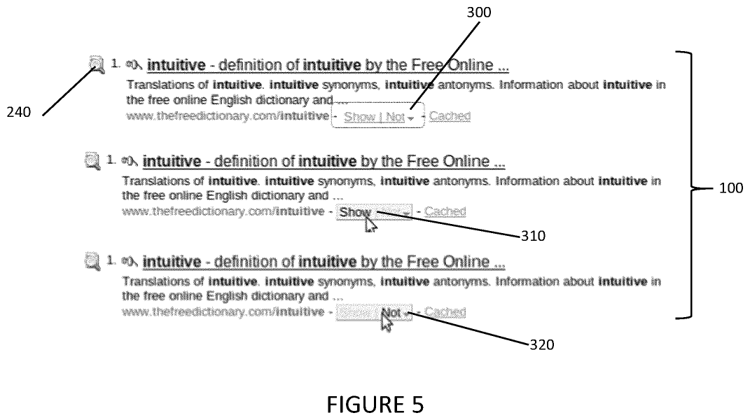

As shown in FIG. 1, in some embodiments, keywords 120 from the search are highlighted in context on the page in the emphasis snapshot 112. The snapshot 110 may be displayed or removed via an interface element such as a toggle button or icon 240 associated with a search result in a search result listing, as shown in FIGS. 2 and 5.

To create the snapshot 110 and to determine the layout and emphasis elements of emphasis snapshot 112 and true depiction 114, the data (e.g. HTML) for the source document is parsed by a parsing engine (e.g. web browser) and the parsed document is rendered into an image, with appropriate color-coding and keyword highlighting incorporated based on the information provided by the parsing engine. The resulting emphasis snapshot 112 is thus a representation of the original document, and may require less rendering time and storage space than an actual preview of the original document. The emphasis snapshot 112 may also be cached or otherwise stored for future use. Similarly, other data associated with the original document that may be used in reviewing the search results (e.g. page date, domain name, etc.) may also be received from the parsing engine. Depending on available processing power and bandwidth, snapshots may be generated in advance and presented as needed, or generated dynamically on triggering from the user (e.g. mouseover). Particularly where processing power, bandwidth or other limitations may limit the timely delivery of snapshot 110, snapshot 110 may only include an emphasis snapshot 112 and not a true snapshot 114. In some embodiments, the contents of snapshot 110 may be automatically determined in response to system specifications, in other embodiments, the contents of snapshot 110 may be set by a user or administrator

In some embodiments, the information highlighted or emphasized by the emphasis snapshot 112 may be the same information used by the search engines in the standard ranking algorithms. The emphasis snapshot 112 is designed to take information which has been chosen as important relevancy information by the ranking algorithms and emphasis this information in a user-friendly manner. This may provide the added benefit of helping users to understand the ranking systems used by search ranking algorithms to better enable the users to take advantage of these systems.

The emphasis snapshot 112 outlines both the document type and the keyword density by incorporating the document's layout into the snapshot while removing customized decoration 130 in order to present as much relevancy information in the snapshot while maintaining legibility. Thus, each emphasis snapshot 112 presents a consistent look to the user throughout the set of results.

In some embodiments, each keyword in emphasis snapshot 112 may be enabled with mouse over 220 or a similar type of functionality to present the associated content or snippet in a pop-up window or tooltip 230, as shown in FIG. 2. Context for the snippets may thereby be enhanced, enabling the user to more efficiently assess the relevance of the associated document. Additionally, the space for snippets may be increased as their presentation is moved outside of the list of results.

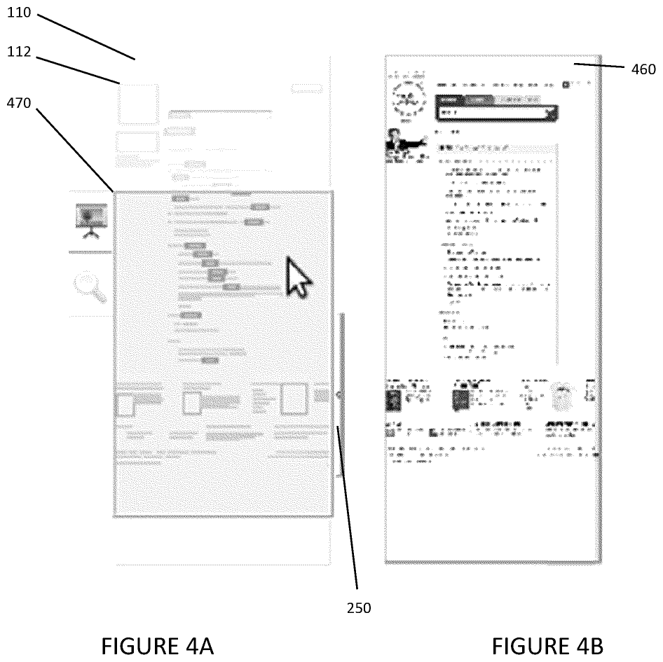

Additionally, by enabling scrolling via scrollbar 250 or other methods of presenting the entire content of the document within the snapshot, the snapshot 110 may be considered complete. For example, as depicted in FIGS. 4A and 4B, a search result 460 may be rendered into an emphasis snapshot 112 of search result 460, and scrollbar 250 may enable the user to view a convenient sized portion or window, such as view port 470, of the entire snapshot 110. The user may then be able to scroll through the entire search result presented in an entire snapshot 110, and may be able to confidently conclude that no potentially relevant items are missed, without the need to access the search result.

In some embodiments, snapshot 110 may be a pop up window triggered by a mouseover event on a search result hyperlink in a list of returned search results. In other embodiments snapshot 110 may be triggered by a mousover event on a dedicated snapshot icon associated with a search result hyperlink. Having a dedicated icon may increase the complexity of a display, but may also permit a user to interact with the pop up only when they are interested in reviewing the pop up.

According to an embodiment, other items in the hyperlinked documents, such as images, in-line videos, hyperlinks, etc. may be described within the emphasis snapshot 112 via symbols or color coding, or both. In some embodiments, the emphasis snapshot 112 may depict the at least a portion of a search result entirely in symbols, replacing text and all other content with symbols such as a colored box indicating a term. Thus, the size and loading time of the emphasis snapshot 112 may be minimized, while also incorporating these items into the relevancy assessment for the user. For example, recognizing a keyword to be part of a caption for an image or video may suggest less relevance than if the keyword is found in the body of the text, particularly if there are few or no other occurrences.

According to an embodiment, the dynamic or scripted elements of the hyperlinked document, such as a webpage, may also be incorporated into the snapshot 110 and the search. Again, color coding or symbols may be used to indicate the presence and type of dynamic content in the emphasis snapshot 112, which may then be assessed for relevance by the user.

Overall, the relevance of the keywords may be considered in light of the user's needs and the greater context of the keyword as presented in the snapshot 110. For example, where a restaurant name is used as a keyword, and the hyperlinked document in the set of results is an online discussion forum, several different contexts are possible:
1) the name appears one or more times in a body of text, which infers a discussion about the restaurant, depending on the density;
2) the name appears in an outbound hyperlink to another website, which infers a link to the restaurant's web site and home page; or
3) the name appears in an inward hyperlink to another page of the same web site, which infers the document may not provide significant information, however the linked page may.

Depending on the user's need in searching the restaurant name, any one of these results may be relevant. By providing the context in the snapshot 110, the user may readily infer the relevance of the document to their query without the need to directly consult each original hyperlinked document.

According to an embodiment, another use of symbols may be to add major document characteristics to the emphasis snapshot 112, either as symbols within the emphasis snapshot 112 itself, or as symbols to generate a mouse over or pop-up containing the characteristic information. Thus, a document may be characterized by length of pages, text dominance, image dominance or video dominance at a glance, further enhancing the user's assessment in both quality and efficiency. In some embodiments, these symbols could also be part of a preliminary snapshot display or interface displayed to the user prior to the user needing to access a full or detailed preview or snapshot.

Therefore, without needing to disrupt an existing interface, both relevant hyperlinked documents and irrelevant hyperlinked documents in the search results may appear clearer to users, depending on their need. The transition moves document relevance from “hard-to-tell” to “hard-to-miss” and all hyperlinked documents in the search results are presented in the snapshots 110, and particularly in the emphasis snapshots 112, in a consistent manner.

With the keywords displayed in context, and complex document structures more simply interpreted with color-coded differentiation between content types (normal txt, internal hyperlink, external hyperlink, image, video, plug-in, etc.), the user may be presented with a more comprehensible and consistent set of results, and may more readily assess relevance of any given result or set of results.

Additionally, in embodiments wherein snapshots 110 are rendered offline or in advance and provided on demand, such as through a pop up interface, the required display time for both the results and the snapshot 110 may be kept to a minimum, avoiding disruption of the user's search process.

Show/Not Menu

Snapshots 110 enable the user to more efficiently and effectively apply keywords to find and select relevant documents. The Show/Not menu assists the user in using non-term conditions, such as date, format and source (website or domain).

While many non-term conditions have been provided to users through advanced search features, differences in presentation allow the use of these conditions to be more intuitive or easier for some users to apply. Different presentations, such as grouping non-term options and presenting non-term options hierarchically makes search options clearer to some users, and permits more options to be contained in a short list of options. Providing users with more options for refining a search may improve the likelihood that a user's needs are properly expressed.

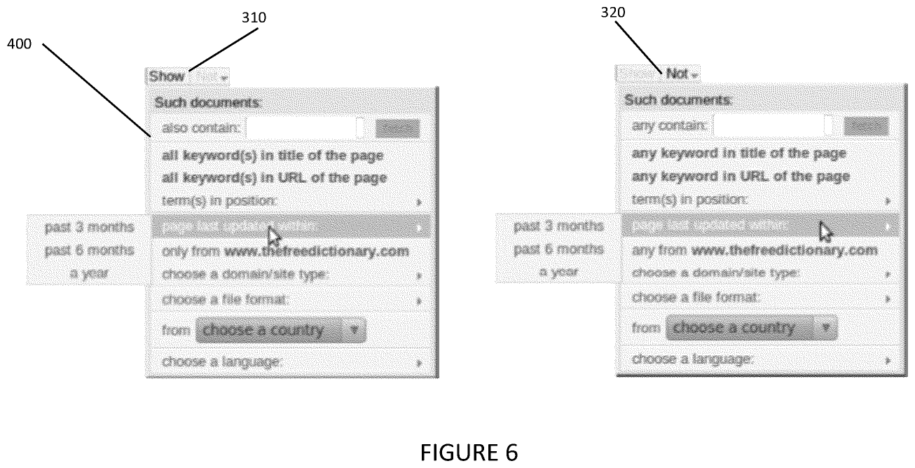

According to an embodiment, each result within the search results may be presented with an interactive button, such as the “Show/Not” menu button 300 as shown in FIG. 5, which, when clicked or moused over, pops-up a context-sensitive menu 400, as shown in FIG. 6, of non-term conditions that can be applied to include (“Show”) 310 or exclude (“Not”) 320 this result and ones with similar non-term properties. The Show/Not or Show/Hide button 300 may include two subbuttons, the Show subbutton 310 and the Not subbutton 320.

In some embodiments, the menu or interactive button may remove or otherwise hide inapplicable options such as options that have already been applied to the list of results, or options that otherwise do not apply to the anchor document. This may simplify the menu or interactive button to enable easier user application. However, in other embodiments, even if an option is not applicable or has already been applied, the interface or dropdown menu provided by the menu or interactive button may appear the same or similar regardless of inapplicable options, as this may improve user familiarity with the location of options. In this embodiment, all options are displayed, even if they are greyed out or otherwise disabled, in order to present a consistent menu and selection process for the user.

The non-term conditions may be used to offset any inconsistency in the results arising from the ranking system, or may be used to efficiently refine a set of results as soon as a relevant or irrelevant result is identified by the user.

In some embodiments, the application of non-term conditions does not affect ranking systems applied by search engines.

According to an embodiment, some of the non-term conditions may be pre-populated with information from the hyperlinked document (the ‘anchor’ document), such as domain name, publication date, etc., which may further accelerate the user's processing of the result and simplify understanding and selection of non-term conditions. Additionally, content-based non-term conditions, such as density of images, videos, or advertisements may be more readily applied in context rather than requiring the user to navigate to a separate page. Furthermore, the non-term conditions may be more readily assessed with the snapshot visible with selection of non-term conditions.

In some embodiments, specific non-term information about the anchor document may be provided through the interactive button. While term or keyword information is shown through a preview image of the anchor document, the non-term information may be contained in the interactive menu button to permit users to obtain detailed non-term information about the anchor document, such as publication date, directly from a search query results listing page.

In some embodiments, the interactive button or menu button is provided for the results listing page rather than for each hyperlinked result. This may reduce the need for interactive buttons throughout the results listings. However, it could also reduce the customization of the Shot/Hide button, if information could not be automatically drawn from a particular anchor document. Preferably an interactive button will be provided in association with each hyperlinked document.

Non-term conditions that may be applied include the page publication or last update date, location of keywords in the page (title, URL, image/video caption), page length (word count), dominant element of page (text, hyperlinks, images, videos, plug-ins, advertisements), site (site-specific pages only), domain (domain-specific pages only), domain type (.com, .org, .net, .gov, etc.), file formats (HTML, PDF, Word, Excel, other), image or advertisement density (number of images or adds on the page), language, country and site type (commercial, news, blog, forum, merchant, etc.).

When a user has stopped at a result, it may be generally understood and expected that the user is expressing interest in the result as the result is either strongly relevant or the opposite. By incorporating the show/not menu 300 directly into the display of the results 100, the user may act on this assumption without breaking the search and review process, and may reduce the trial-and-error associated with existing search processes and results.

Also, the layout of the show/not menu 400 may permit a single application of a single conditions at a time, which may be desirable to render the logic clearer to the user, and may make it easier to follow and track changes in the conditions as well as their impact.

Additionally, users may no longer be required to go back and forth between hyperlinked documents to compare or filter results, as well as being provided with a consistent interface for interpreting results regardless of the search engine or ranking system used to generate the set of results.

Users may also find applying a non-term condition, either to show or to hide results associated with the non-term condition, more intuitive if they are able to relate that condition to an example document. Thus, a user may find it more intuitive to decide to modify a listing of search results by hiding search results published within the last month using a Not subbutton 320 of the Show/Hide button 300 when that Show/Hide button 300 is near an irrelevant document published in the last month.

Additionally, by providing intuitive access to non-term conditions, a search interface may be able to provide search functionality similar to a vertical search engine.

The Show/Hide button 300 could be integrated with the snapshot function described above. Integration may enable more intuitive application of non-term conditions such as page length, image size or density, hyperlink types or density, and precise term positioning, as the user will be able to see how these non-term conditions appear in an example document. Integration may involve simply utilizing the Show/Hide and snapshot functions in parallel with the same results set, or may involve more direct integration such as moving the Show/Hide button to be a part of the snapshot button or the snapshot pop up. Integration by using the two functions in parallel may beneficially allow a user to interact with one function without being distracted or confused by the other.

Webrarian

According to an embodiment, an additional component, which may be integrated to further enhance the functionality of the snapshot 110 and the show/not menu 400, is a webrarian. The webrarian is an interface or method of organizing or presenting search results. The webrarian assist in dynamically tracking search queries and modifications, and recording and managing a search session as the user proceeds through multiple search requests and refinements through application of keywords and non-term conditions.

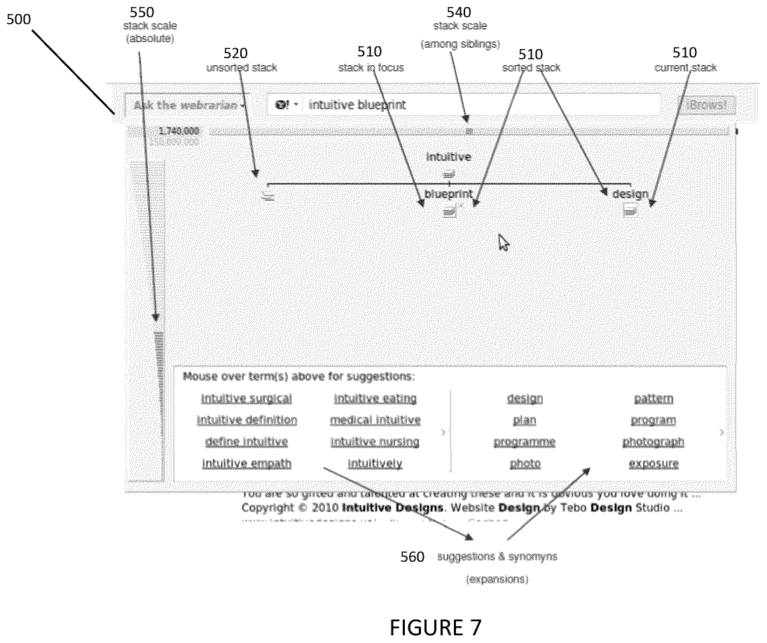

The webrarian manages the search session through a search session tracker 500, as shown in FIG. 7, which organizes queries and results into a tree-like structure. Each node or stack 510 in the tree represents an element—keyword or non-term condition—that remains consistent throughout the session. The path from the topmost node represents one search request which contains all of the keywords and non-term conditions used along the path. Thus, the tree “branches” into a new node whenever a new term or condition is added.

An “unsorted” stack or node 520 is created for each set of branches from the same node, except the initial or parent node. The unsorted stacks contain information that the user has discarded from the original query, but is preserved for future access and relevance. In some cases, multiple unsorted stacks or nodes may be required. For example, where a user adds a condition “between $100 and $1000” to a search, an unsorted stack or node is created for results “less than $100” and another unsorted stack or node is created for results “greater than $1000”. Thus, as requests are made, documents being targeted/searched may migrate from one sorted or unsorted stack or node to another but each and every document always remains represented by at least one of the stacks or nodes in the tree structure, even if term or non-term conditions matching that document have not yet been entered by the user during their modifications of the initial search query.

The relative sizes of the stacks are shown as absolute scales 540 and 550, both within the tree and the unsorted stacks, and may be used by the user to determine the likelihood of a relevant document being contained within a particular stack. As the tree grows over time, the underlying file collection remains unaffected, such the resuming or revisiting a search may be more user-friendly, as results do not need to be regenerated unless the user explicitly requests that it be done.

A user may access a listing of hyperlinked documents represented by a node or stack, such as by clicking on the node or stack. This may permit a user to jump between different search queries or jump between a highly refined search and a more general search, as desired. The search tree presentation also may assist a user in seeing the logic or relationships between keywords or terms and non-term conditions, without displaying synthetic operators, rules, syntax, or conventions, which may result in a search query that is difficult to understand or modify.

The webrarian may further include a recommendation area 560, which may be dynamically updated according to the user's choice of keywords, with two sections: one to show potential terms and conditions to extend the tree deeper, for greater precision, and another to potential terms (i.e. synonyms) and conditions to extend the tree wider, for greater coverage. Normally users may only be able to try to obtain some disproportionate/unwarranted clues to such information by randomly going through individual files one by one themselves, or by keeping a thesaurus handy at all times.

Recommended terms or non-term conditions for focusing or broadening a search may be the result of curated lists of relevant terms, machine learning, or similar methods of selecting recommended terms or non-term conditions. For example, suggestions could reflect the most popular queries on the web, statistical information from the collection returned by the search query such as the number of times a potential synonym appears, history based suggestions resulting from the user's past activities, etc.

By implementing the unsorted stack with the results, a thus-enabled divide-and-conquer mechanism ensures that no content may be lost or missed, reducing the penalty for “wrong” choices by providing an alternative route to access results. The automatically generated complementing search result sets make computer-aided searching more aligned with how a human user would finish a sorting task on piles of concrete objects using our well-established everyday routines, such as workload-overviewing/auditing, focus-switching, history/progress-tracking, job-halting-and-resuming, correctness/error-verifying, etc. All these routines assist in properly finishing the task. Additionally, the node structure is scalable, permitting the user to take multiple and varied approaches to splitting the results, without losing the underlying files from the original search.

Furthermore, using trees allows for individual files or documents to appear from different original search requests without exclusions, as the scale and scope of the entire set of results is visible at all times to the user.

The webrarian may further distinguish results using the document type information from the snapshot (i.e. link-rich, image-rich, video-rich) and organize the stacks accordingly, enabling the user to more readily identify stacks which contain relevant documents based on the user's needs. Similarly, groupings by non-term conditions (domain, date published, etc.) may also be performed. The webrarian manages the search session through a search session tracker 500. And because this session tracker tree-like structure is independent to the underlying physical data storage, so, no matter if the data being searched is (indexed) Internet web pages (through a search engine), or if it is files stored on a personal computing device (through its OS file system), or if it is a private music collection that the user wants to have more flexibly catalogued, the webrarian component may always manage the queries for them. By maintaining related queries together, this tree structure is able not only to preserve the history information for the search sessions, but also, more importantly, to compensate the once-isolated (once-ad-hoc-in-nature) sporadic search attempts with the efficiency, completeness and robustness derived from the intuitive divide-and-conquer strategy. It then may help users achieve their ultimate goal of searching—data retrieval—in a more orderly and exhaustive manner, by making navigation and explorations of the entire collection possible using simple and flexible searches without extra effort from the users' side.

Searches involving synonyms or parallel terms may be placed at the same level or tier of a search tree, wherein each level or tier includes all nodes connected to a particular preceding node. For example, a tree may be initiated by an initial query represented by an initial node, all subsequent modifications of that initial query may be represented by nodes in a first level or tier under the initial node. These first tier nodes or first tier child nodes representing the subsequent modifications of the initial query may be visually connected to the initial or parent node in the tree, such as by lines or other connections. If the already modified search query is subsequently further modified, addition of tiers or levels of child nodes may be added representing the additional modifications. These lower tiers or levels may be connected to one or more higher or earlier tier child nodes, for example by means of a visual line. If an initial query is modified into two or more top or first tier child nodes, each of these child nodes may be further modified into second tier child nodes. Second and subsequent tier child nodes may exist together on a single tier while being connected to different higher or earlier tier child nodes.

Search modifications may be represented by nodes placed automatically into the tree as a result of the search query or modified search query to which the user applies the subsequent modification. However, as the users search progresses the user may wish to move these search terms, represented by associated nodes or stacks, to a different level or tier along the same search path or another search path. Users may also wish to combine search terms into a common search modification or node or stack. This may be done automatically, for example, by the user entering an instruction to move or remove all nodes containing a certain term or non-term condition, or by applying machine learning algorithms to adjust the structure of the tree in connection with past apparent user preferences. However, this may also be done manually, for example by dragging and dropping nodes or stacks. Manual adjustment of the search tree may have the benefit of permitting clear user direction of changes to the search tree, permitting direct user control over the development of the search.

Some search sessions may require multiple trees. For example, a search session may result in a user wishing to apply a search query containing a synonym of a keyword used in an initial search query; in which case adding nodes to the initial tree created for the initial search query would not accurately represent the modified search. As trees are added to the webrarian search session, a user may be permitted to switch between them or may choose to have all trees displayed together.

In some embodiments, statistics information may be provided. For example, a mouse-over event in relation to a particular node may trigger the display of meta-data without resulting in the documents represented by the node being delivered in a search result listing. Meta-data may include the size of the document set represented by the node, the size of the document set represented by the node compared to the total number of documents returned by the initial search, etc.

In some embodiments, webrarian searches and organization may also be saved by a user for later use. As the webrarian structure may only represent the search query applied in the associated search engine, some embodiments may permit the search organization to be saved separately from a web page or search engine and applied to a search when the user desires. For example, search trees may be made statically available for future reference or modification by being bookmarked on the client side as HTTP POST parameters, or stored on the server side and identified by cookies and session ID's.

Webrarian organization and presentation may help manage the complexity of searching, keep track of search and search modification attempts, provide an overview of the search process which can be reviewed for efficiency and improvement, permit users to organize a collection of search results or documents for later searching, provide the same treatment for term and non-term search conditions, reveal relationships between search terms or non-term conditions, provide recommendations and suggestions, reveal relationships between the document or result set size returned by different queries, permit advanced search functionality without requiring the trouble of accessing advance search screens, offer advanced search functionality without intruding into regular search functionality if the advanced options are not desired, etc.

In some embodiments, some tiers may not be displayed in a search tree depiction with which a user interacts. In particular, in some embodiments the initial parent node may not be displayed. For example, a programmer may want to group all programs or applications for better accessibility and may use categories such as system management programs, programs that do read-only operations, programs that do all read-write operations, and an ‘unsorted’ category of all other programs; these categories may be presented without presenting a connected parent node even though these may be child nodes in a tree based on an implied ‘all programs’ parent node.

In other embodiments, the search tree depiction may only present the parent and child nodes with which the user is interacting or has recently interacted with. For example, the search tree depiction may display only a depiction of the branches of a search tree which directly connect to a node the user is interacting with, alternatively a search tree depiction may be based on machine learning algorithms and may display only what the user is likely to wish to interact with.

The present invention may be embodied in other specific forms without departing from the spirit or essential characteristics thereof. Certain adaptations and modifications of the invention will be obvious to those skilled in the art. Therefore, the presently discussed embodiments are considered to be illustrative and not restrictive, the scope of the invention being indicated by the appended claims rather than the foregoing description and all changes which come within the meaning and range of equivalency of the claims are therefore intended to be embraced therein.

What is claimed is:

1. A method of generating and presenting enhanced search results to a user of a search engine who has executed a search query using one or more keywords, comprising:
receiving a set of search results in response to the search query made by the user;
generating, for each document hyperlinked to a search result, a preview document image that identifies the keywords from the search query found in the hyperlinked document using a color-based scheme or a symbol-based scheme or combination of both; and
presenting the set of search results in a document with a user interface element for each document hyperlinked to a search result which when activated causes the associated preview document image to be displayed to the user.

2. The method of claim 1, wherein the color-based scheme or symbol-based scheme or combination of both further identifies one or more of the following: text, images, videos, hyperlinks and plug-ins in the hyperlinked document.

3. The method of claim 1, wherein the color-based scheme or symbol-based scheme or combination of both further identifies scripted elements within the hyperlinked document.

4. The method of claim 1, wherein the preview document image identifies non-visible elements associated with the hyperlinked document.

5. The method of claim 4, wherein the non-visible elements include one or more of the following elements: document length, document format, and date of publication.

6. The method of claim 1, further including associating with each document a menu to show or hide related results based on non-keyword conditions.

7. The method of claim 6, wherein the non-keyword conditions include at least one of the following conditions: date published, file format, image density, video density, hyperlink density and domain name.

8. The method of claim 1, wherein the user interface element is a toggle which allows the user to toggle on or off whether to display the associated preview document image.

9. The method of claim 1, wherein the preview document image comprises an emphasis preview document image and a true preview document image, and the user interface further includes a toggle to allow the user to transition the preview document image between the emphasis preview document image and the true preview document image.

10. The method of claim 1, wherein the preview document image includes the entire search result displayed through a view port, the view port movable by means of a scrollable display element.

11. The method of claim 1, wherein the preview document image is context-enabled such that actual content of the document is displayed when the user interacts with the preview document image.

12. The method of claim 11, wherein the user interaction is provided as a mouse over the preview document image and the actual content is display as a pop-up.

13. The method of claim 1, further comprising:
receiving a user interaction with a snippet of the preview document; and
generating a tooltip providing one or more of detailed content, increased snippet size presentation, and snippet context.

14. A non-transient, computer-readable medium containing computer-readable instructions, which when executed by a processor cause the computer to:
receive a set of search results in response to the search query made by the user;
generate, for each document hyperlinked to a search result, a preview document image that identifies the keywords from the search query found in the hyperlinked document using a color-based scheme or a symbol-based scheme or combination of both; and
present the set of search results in a document with a user interface element for each document hyperlinked to a search result which when activated causes the associated preview document image to be displayed to the user.

15. The computer-readable medium of claim 14, wherein the color-based scheme or symbol-based scheme or combination of both further identifies one or more of: text, images, videos, hyperlinks and plug-ins from the document.

16. The computer-readable medium of claim 14, wherein the color-based scheme or symbol-based scheme or combination of both further identifies scripted elements within the hyperlinked document.

17. The computer-readable medium of claim 14, wherein the preview document image identifies non-visible elements associated with the hyperlinked document.

18. The computer-readable medium of claim 17, wherein the non-visible elements include one or more of the following elements: document length, document format, and date of publication.

19. The computer-readable medium of claim 14, wherein the user interface element is a toggle which allows the user to toggle on or off whether to display the associated preview document image.

20. A method of presenting a user with non-term search options and refining a set of hyperlinked search results of a search session, comprising:
receiving the set of hyperlinked search results in response to a search query made by the user;
generating, for each hyperlinked search result, an interactive button permitting the user to set an at least one non-term search condition to be applied to the set of hyperlinked search results;
applying the at least one non-term search condition to the set of hyperlinked search results to obtain a refined set of hyperlinked search results; and
presenting the refined set of hyperlinked search results to the user.

21. The method of claim 20, wherein the button provides a drop down menu containing the at least one non-term search condition.

22. The method of claim 20, wherein the at least one non-term search condition is at least one of: date published, file format, image density, video density, hyperlink density, and domain name.

23. The method of claim 21, wherein the drop down menu includes an at least one submenu.

24. The method of claim 21, wherein the drop down menu is customized to the corresponding hyperlinked search result.

25. The method of claim 24, wherein the drop down menu includes the site name of the corresponding hyperlinked search result.

26. The method of claim 24, wherein the drop down menu includes the update date of the corresponding hyperlinked search result.

27. The method of claim 20, wherein the interactive button contains a show subbutton and a hide subbutton, the show subbutton permitting a user to apply a desired non-term condition to show search results to which the desired non-term condition applies, and the hide subbutton permitting a user to apply an undesired non-term condition to hide search results to which the undesired non-term condition applies.

28. A method of presenting a search session to a user, comprising:
receiving a search query from the user, the search query containing one or more terms or non-term conditions;
presenting the user's search query to the user as a search tree, the search tree containing a first parent node representing the search query;
presenting the user with a first query-focusing term or non-term condition, the first query-focusing term or non-term condition available to modify the search tree to add a first tier first child node connected to the first parent node, the first tier first child node representing the first query-focusing term or non-term condition;
presenting the user with a first query-broadening term or non-term condition, the first query-broadening term or non-term condition available to modify the search session presentation to add a supplemental search tree containing a second parent node, the second parent node representing the first search query as modified by the first query-broadening term or non-term condition;
receiving a first search query modification request from the user, the first search query modification request modifying the search query to add or remove a first term or non-term condition;
modifying the search tree to add a first tier first child node, the first tier first child node connected to the first parent node and representing the first search query modification; and
modifying the search tree to add an at least one first tier unsorted child node, the at least one first tier unsorted child node connected to the first child node and representing the search query less the first search query modification.

29. The method of claim 28, wherein the user is able to manually adjust the search tree.

30. The method of claim 28, further comprising the steps of:
receiving a second search query modification request from the user, the second search query modification request modifying the search query to add or remove a second term or non-term condition;
modifying the search tree to add a first tier second child node, the first tier second child node connected to the first parent node and representing the second search query modification; and
modifying the at least one first tier unsorted child node to represent the search query less the search query as modified by the first search query modification and search query as modified by the second search query modification.

31. The method of claim 30, further comprising the steps of:
receiving a request from the user to combine the first tier first child node and the first tier second child node; and
modifying the search tree to combine the two nodes into a combined child node, the combined child node representing the first and second search query modifications.

32. The method of claim 28, further comprising the steps of:
receiving a second search query modification request from the user, the second search query modification request modifying the search query as modified by the first search query modification request to add or remove a second term or non-term condition;
modifying the search tree to add a second tier first child node, the second tier first child node connected to the first tier first child node and representing the second search query modification; and
modifying the search tree to add an at least one second tier unsorted child node, the at least one second tier unsorted child node connected to the first tier first child node and representing the search query as modified by the first search query modification less the second search query modification.

33. The method of claim 32, further comprising the steps of:
receiving a request from a user to reposition the second tier first child node to the first tier; and
modifying the search tree to remove the second tier first child node and add a first tier second child node, the first tier second child node representing the same modification as the second tier first child node;
modifying the search tree to remove the at least one second tier unsorted child node; and
modifying the at least one first tier unsorted child node to represent the search query less the search query as modified by the first search query modification and search query as modified by the second search query modification.

34. The method of claim 28, further comprising the step of presenting the user, for each node of the search tree, with meta data.

35. The method of claim 34, wherein the meta data is a representation of the number of search results returned by the search query as represented by the node.

36. The method of claim 28, further comprising the steps of:
receiving a user request to view a selected set of search results corresponding to a selected search query represented by a selected node; and
displaying the selected search results to the user;

37. The method of claim 28, wherein in the search tree presented to the user the parent node is hidden.

38. The method of claim 28, wherein in the search tree presented to the user only the nodes with which the user has interacted within a predetermined time are displayed.
